(19) United States
(12) Patent Application Publication
(10) Pub. No.: US 2018/0340568 A1
(43) Pub. Date: Nov. 29, 2018

(54) PROPELLER SHAFT FOR VEHICLE

(71) Applicant: TOYOTA JIDOSHA KABUSHIKI KAISHA, Toyota-shi (JP)

(72) Inventors: Atsuo Mikazuki, Toyota-shi (JP); Kohki Kawarada, Toyota-shi (JP)

(73) Assignee: TOYOTA JIDOSHA KABUSHIKI KAISHA, Toyota-shi (JP)

(21) Appl. No.: 15/986,325

(22) Filed: May 22, 2018

(30) Foreign Application Priority Data
May 26, 2017 (JP) 2017-104473

(51) Int. Cl. F16C 3/03; F16D 3/06; F16N 7/36

(52) U.S. Cl. CPC F16C 3/03; F16D 3/06; F16D 2300/06; F16C 2326/06; F16N 7/363

(57) ABSTRACT

A propeller shaft includes a first hollow shaft coupled to a first joint so as to transmit motive power to the first joint, a second hollow shaft coupled to a second joint so as to transmit motive power to the second joint, and a partitioning wall dividing an inner space of an inward shaft into a lubrication oil retaining chamber and a vacant chamber. The second hollow shaft is fitted to the first hollow shaft in such a manner as to be non-rotatable relative to the first hollow shaft, and to be movable in a rotation axis direction of the first hollow shaft. The first hollow shaft and the second hollow shaft are configured such that lubrication oil is supplied to a fitted part, the inward shaft is one of the first hollow shaft and the second hollow shaft, and the inward shaft is inwardly fitted.

### INCORPORATION BY REFERENCE

The disclosure of Japanese Patent Application No. 2017-104473 filed on May 26, 2017 including the specification, drawings and abstract is incorporated herein by reference in its entirety.

### BACKGROUND

### 1. Technical Field

The present disclosure relates to a propeller shaft for a vehicle.

### 2. Description of Related Art

There has been known a propeller shaft for a vehicle including: a first shaft; a second shaft fitted to the first shaft so as to be non-rotatable relative to the first shaft, and also to be movable in the rotation axis direction of the first shaft; and a lubrication oil retaining chamber that retains lubrication oil therein being disposed inside an inward shaft, which is one of the first shaft and the second shaft, the one located more inward than the other, wherein the lubrication oil is supplied to a part where the first shaft and the second shaft are fitted to each other. For example, an example of such a propeller shaft for a vehicle is a propeller shaft for a vehicle described in Japanese Utility Model Application Publication No. 62-006127.

### SUMMARY

Meanwhile, in the propeller shaft for the vehicle as described in JP 62-006127U, by filling the lubrication oil retaining chamber formed inside the inward shaft with the lubrication oil, a sufficient amount of the lubrication oil is supplied to a part where the first shaft and the second shaft are fitted to each other so as to maintain lubrication property at the fitted part between the first shaft and the second shaft. If the inside of the propeller shaft for the vehicle is charged with the lubrication oil such that the lubrication oil retaining chamber formed inside the inward shaft is filled with the lubrication oil, amount of the lubrication oil with which the inside of the propeller shaft for the vehicle is charged becomes increased. To cope with this, it can be considered to reduce the amount of the lubrication oil with which the inside of the propeller shaft for the vehicle is charged; but if the amount of the lubrication oil with which the propeller shaft for the vehicle is charged is reduced, it might be impossible to supply a sufficient amount of the lubrication oil to the part where the first shaft and the second shaft are fitted to each other in some cases.

The present disclosure provides a propeller shaft for a vehicle capable of maintaining lubrication property at a part where a first shaft and a second shaft are fitted to each other, and also suitably reducing amount of lubrication oil with which the inside of the propeller shaft for the vehicle is charged.

A first aspect of the present disclosure is a propeller shaft for a vehicle. The propeller shaft includes a first hollow shaft, a second hollow shaft and a partitioning wall, the first hollow shaft coupled to a first joint so as to transmit motive power to the first joint, the second hollow shaft coupled to a second joint so as to transmit motive power to the second joint, the second hollow shaft being fitted to the first hollow shaft in such a manner as to be non-rotatable relative to the first hollow shaft, and to be movable in a rotation axis direction of the first hollow shaft, the first hollow shaft and the second hollow shaft being configured such that lubrication oil is supplied to a fitted part between the first hollow shaft and the second hollow shaft, the partitioning wall dividing an inner space of an inward shaft into a lubrication oil retaining chamber that retains the lubrication oil and a vacant chamber, the inward shaft being one of the first hollow shaft and the second hollow shaft, the inward shaft being inwardly fitted.

With the above aspect, it is possible to maintain lubrication property at the part where the first hollow shaft and the second hollow shaft are fitted to each other, and also to suitably reduce amount of the lubrication oil with which the inside of the propeller shaft for the vehicle is charged.

In the propeller shaft of the first aspect, the inward shaft may have oil holes, and the inward shaft may be configured such that the lubrication oil in the lubrication oil retaining chamber is supplied through the oil holes to the fitted part.

With the above aspect, it is possible to suitably supply the lubrication oil in the lubrication oil retaining chamber to the part where the first hollow shaft and the second hollow shaft are fitted to each other.

In the propeller shaft of the first aspect, the inward shaft may be the first hollow shaft, and the first hollow shaft may include first outer circumferential spline teeth on an outer circumference of the first hollow shaft. The second hollow shaft may include first inner circumferential spline teeth on an inner circumference of the second hollow shaft. The first outer circumferential spline teeth may be configured to be spline-fitted to the first inner circumferential spline teeth.

With the above aspect, it is possible to maintain lubrication property at the part where the first outer circumferential spline teeth of the first hollow shaft and the first inner circumferential spline teeth of the second hollow shaft are spline-fitted to each other, and also to suitably reduce the amount of the lubrication oil with which the inside of the propeller shaft for the vehicle is charged.

In the propeller shaft of the first aspect, a first cover having a cylindrical shape may be fixed to a first end portion of the first hollow shaft, the first end portion being adjacent to the first joint, the first cover may define a cylindrical first space around an outer circumference of the first end portion of the first hollow shaft, and a distal end portion of the second hollow shaft may be disposed in the cylindrical first space. When the first hollow shaft and the second hollow shaft move in a predetermined direction, the lubrication oil moving between the lubrication oil retaining chamber and the cylindrical first space may be supplied between the first outer circumferential spline teeth of the first hollow shaft and the first inner circumferential spline teeth of the second hollow shaft. The predetermined direction may be any one of a direction where the first hollow shaft and the second hollow shaft move apart from each other and a direction where the first hollow shaft and the second hollow shaft approach each other.

With the above aspect, it is possible to suitably maintain lubrication property at the part where the first outer circumferential spline teeth of the first hollow shaft and the first inner circumferential spline teeth of the second hollow shaft are spline-fitted to each other.

In the propeller shaft of the first aspect, the inward shaft may be the second hollow shaft, the second hollow shaft may include second outer circumferential spline teeth on an outer circumference of the second hollow shaft, the first hollow shaft may include second inner circumferential spline teeth on an inner circumference of the first hollow shaft, and the second outer circumferential spline teeth may be configured to be spline-fitted to the second inner circumferential spline teeth.

With the above aspect, it is possible to maintain lubrication property at the part where the second inner circumferential spline teeth of the first hollow shaft and the second outer circumferential spline teeth of the second hollow shaft are spline-fitted to each other, and also to suitably reduce the amount of the lubrication oil with which the inside of the propeller shaft for the vehicle is charged.

In the propeller shaft of the first aspect, a second cover having a cylindrical shape may be fixed to a third end portion of the second hollow shaft, the third end portion being adjacent to the second joint, the second cover may define a cylindrical second space around an outer circumference of the third end portion of the second hollow shaft, and a distal end portion of the first hollow shaft may be disposed in the cylindrical second space. When the first hollow shaft and the second hollow shaft move in a predetermined direction, the lubrication oil moving between the lubrication oil retaining chamber and the cylindrical second space may be supplied between the second inner circumferential spline teeth of the first hollow shaft and the second outer circumferential spline teeth of the second hollow shaft. The predetermined direction may be any one of a direction where the first hollow shaft and the second hollow shaft move apart from each other and a direction where the first hollow shaft and the second hollow shaft approach each other.

With the above aspect, it is possible to suitably maintain lubrication property at the part where the second inner circumferential spline teeth of the first hollow shaft and the second outer circumferential spline teeth of the second hollow shaft are spline-fitted to each other.

In the propeller shaft of the first aspect, the partitioning wall may be fixed inside the inward shaft.

With the above aspect, it is possible to divide the inner space of the inward shaft into the lubrication oil retaining chamber and the vacant chamber.

In the propeller shaft of the first aspect, the partitioning wall may be provided inside the inward shaft in such a manner as to be movable relative to the inward shaft in a rotation axis direction of the inward shaft.

With the above aspect, it is possible to suitably suppress leakage of the lubrication oil from the propeller shaft for the vehicle.

In the propeller shaft of the first aspect, the inward shaft may be the first hollow shaft, the first hollow shaft may have a first end portion adjacent to the first joint, a second end portion distant from the first joint, and the oil holes provided at the second end portion, the partitioning wall may include an annular fixed part fixed to an inner circumferential wall surface of the first hollow shaft, and a bottomed cylindrical projection projecting from the fixed part toward a second end portion side, and an outer diameter of the bottomed cylindrical projection may be smaller than an inner diameter of the first hollow shaft.

With the above aspect, it is possible to suitably enlarge the vacant chamber in the inner space of the inward shaft, while maintaining lubrication property at the part where the first hollow shaft and the second hollow shaft are fitted to each other.

In the propeller shaft of the first aspect, the inward shaft may be the second hollow shaft, the second hollow shaft may have a third end portion adjacent to the second joint, a forth end portion distant from the second joint, and the oil holes provided at the forth end portion, the partitioning wall may include an annular fixed part fixed to an inner circumferential wall surface of the second hollow shaft, and a bottomed cylindrical projection projecting from the fixed part toward a forth end portion side, and an outer diameter of the bottomed cylindrical projection may be smaller than an inner diameter of the second hollow shaft.

With the above aspect, it is possible to suitably enlarge the vacant chamber in the inner space of the inward shaft, while maintaining lubrication property at the part where the first hollow shaft and the second hollow shaft are fitted to each other.

In the propeller shaft of the first aspect, the partitioning wall may be composed by an elastic material that is elastically deformable.

With the above aspect, it is possible to suitably suppress leakage of the lubrication oil from the propeller shaft for the vehicle.

In the propeller shaft of the first aspect, the inward shaft may be the first hollow shaft having oil holes, and the lubrication oil retaining chamber may be a space communicating with the oil holes.

In the propeller shaft of the first aspect, the inward shaft may be the second hollow shaft having oil holes, and the lubrication oil retaining chamber may be a space communicating with the oil holes.

In the propeller shaft of the first aspect, the vacant chamber may retain no lubrication oil.

In the propeller shaft of the first aspect, the bottomed cylindrical projection may project to a position corresponding to the oil holes in an extending direction of the rotation axis of the first hollow shaft.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a view explaining a schematic configuration of a hybrid vehicle to which the present disclosure is applied;

FIG. 2 is a view explaining a configuration of a propeller shaft provided to the hybrid vehicle in FIG. 1;

FIG. 3 is a view explaining a configuration of a first shaft part of the propeller shaft in FIG. 2 in detail;

FIG. 4 is a view showing a state in which an inside of the first shaft part of the propeller shaft in FIG. 2 is filled with grease;

FIG. 5 is a view showing a state in which an inside of the propeller shaft in FIG. 2 whose grease cover is removed is filled with the grease;

FIG. 6 is a view showing a flow of the grease inside the propeller shaft when the first hollow shaft and the second hollow shaft move in a direction apart from each other, or move in a direction approaching each other during vehicle traveling;

FIG. 7 is a view showing a propeller shaft of another embodiment of the present disclosure, and is a view explaining a configuration of a first shaft part of the propeller shaft;

FIG. 8 is a view showing a flow of the grease inside the propeller shaft in FIG. 7 when the first hollow shaft and the second hollow shaft move in a direction apart from each other, or move in a direction approaching each other during vehicle traveling; and

FIG. 9 is a view showing a propeller shaft of another embodiment of the present disclosure, and is a view explaining movement of a grease cover inside the propeller shaft when the second hollow shaft moves in a direction approaching the first hollow shaft during vehicle traveling.

### DETAILED DESCRIPTION OF EMBODIMENTS

Hereinafter, embodiments of the present disclosure will be described with reference to the drawings. In the following embodiments, the drawings are appropriately simplified or modified, and dimensional ratios and shapes of the respective components are not always accurately depicted.

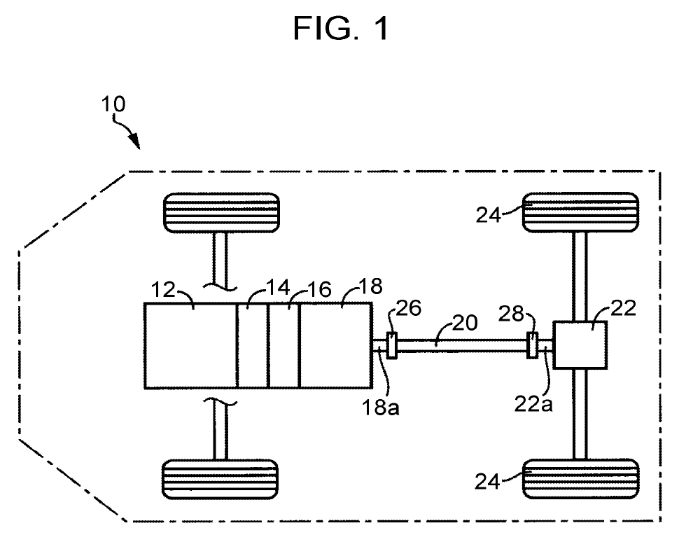

FIG. 1 is a view explaining a schematic configuration of a hybrid vehicle 10 to which the present disclosure is applied. In FIG. 1, the hybrid vehicle 10 is of an FR (front-engine rear-drive) type, and includes, as drive power sources, an engine 12 that is an internal combustion engine such as a gasoline engine and a diesel engine, and a motor generator 14 functioning as an electric motor and an electric power generator. Drive power outputted from the engine 12 and the motor generator 14 is transmitted from a torque converter 16 that is a fluid-type power transmission system to an automatic transmission 18, and further via a propeller shaft (a propeller shaft for a vehicle) 20 to a differential gear unit 22 so as to drive right and left driven wheels 24.

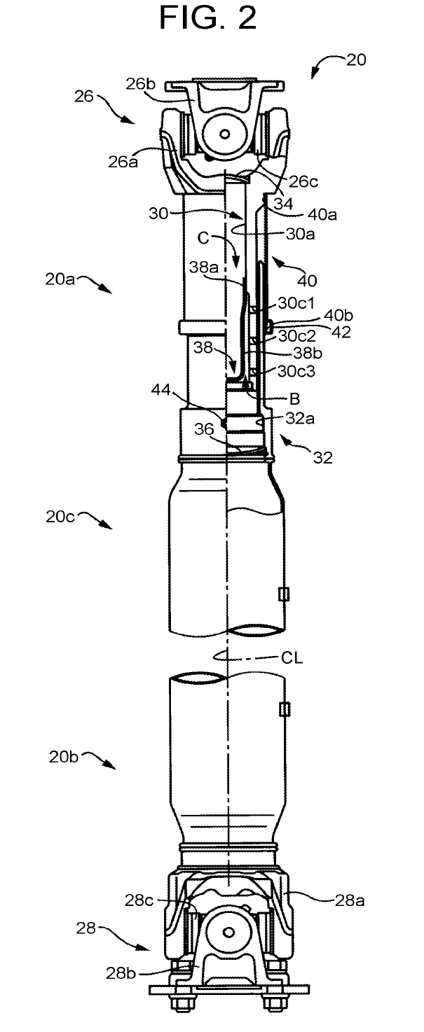

FIG. 2 is a view explaining a configuration of the propeller shaft 20 to which the present disclosure is applied. As shown in FIG. 2, the propeller shaft 20 includes: a first shaft part 20a in a shaft shape coupled to an output shaft 18a (see FIG. 1) of the automatic transmission 18 so as to transmit motive power to the output shaft 18a through a first universal joint (a first joint) 26; a second shaft part 20b in a shaft shape coupled to an input shaft 22a (see FIG. 1) of the differential gear unit 22 so as to transmit motive power to the input shaft 22a through a second universal joint (a second universal joint) 28; and a coupling shaft portion 20c in a shaft shape that couples the first shaft part 20a and the second shaft part 20b to each other.

As shown in FIG. 2, the first universal joint 26 includes: a bifurcated first yoke 26a composing an end portion on the automatic transmission 18 side of the first shaft part 20a; a bifurcated second yoke 26b coupled to the output shaft 18a of the automatic transmission 18 so as to transmit motive power to the output shaft 18a; and a cross shaft 26c that connects the first yoke 26a to the second yoke 26b in a rotatable manner. In addition, as shown in FIG. 2, the second universal joint 28 includes: a bifurcated first yoke 28a composing an end portion on the differential gear unit 22 side of the second shaft part 20b; a bifurcated second yoke 28b coupled to an input shaft 22a of the differential gear unit 22 so as to transmit motive power to the input shaft 22a; and a cross shaft 28c that connects the first yoke 28a to the second yoke 28b in a rotatable manner.

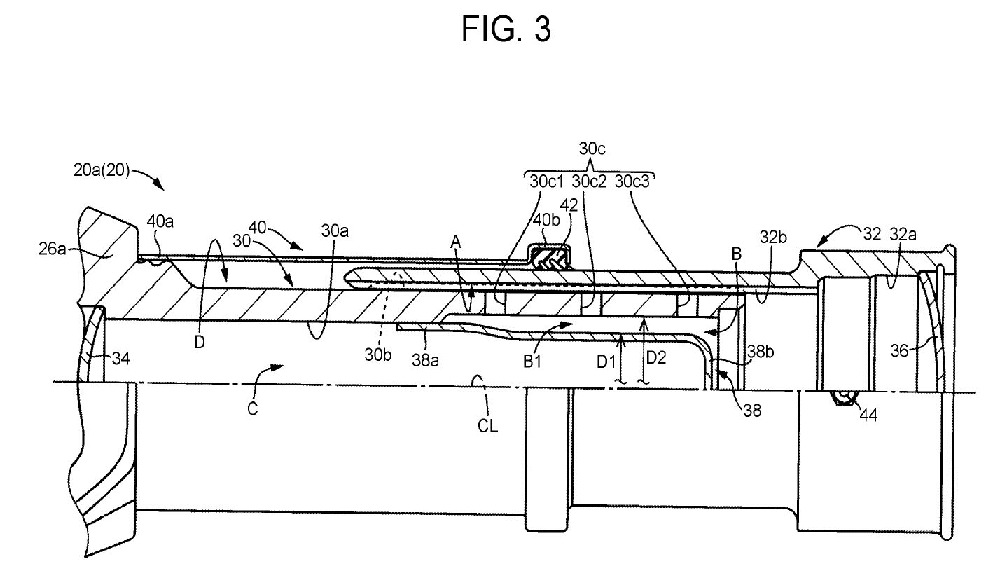

As shown in FIG. 3, the first shaft part 20a of the propeller shaft 20 includes: a first hollow shaft 30 configured to be hollow and coupled to the first yoke 26a of the first universal joint 26 so as to transmit motive power to the first yoke 26a; and a second hollow shaft 32 configured to be hollow and coupled to the first yoke 28a of the second universal joint 28 via the coupling shaft portion 20c and others so as to transmit motive power to the first yoke 28a.

As shown in FIG. 3, the first yoke 26a of the first universal joint 26 is integrally coupled to an end portion of the first hollow shaft 30, the end portion located on the first universal joint 26 side, and the first hollow shaft 30 is coupled to the output shaft 18a of the automatic transmission 18 via the first universal joint 26 so as to transmit motive power to the output shaft 18a. The first hollow shaft 30 is formed with a first hole part (an inner space) 30a in a cylindrical shape extending through the first hollow shaft 30 in a rotation axis direction of the first hollow shaft 30, that is, in a direction of a rotation axis (axial line) CL of the propeller shaft 20. In addition, a disk-shaped first cover 34 covering an opening on the first universal joint 26 side of the first hollow shaft 30 is fitted into the end portion on the first universal joint 26 side of the first hollow shaft 30. The end portion of the first hollow shaft 30 located on the first universal joint 26 side is an example of a first end portion adjacent to the first universal joint 26.

As shown in FIG. 2, an end portion of the second hollow shaft 32, the end portion located on the opposite side to the first universal joint 26 side, is integrally coupled to the coupling shaft portion 20c of the propeller shaft 20 through welding or the like; and the second hollow shaft 32 is coupled to the input shaft 22a of the differential gear unit 22 via the coupling shaft portion 20c and the second shaft part 20b of the propeller shaft 20, the second universal joint 28, and others so as to transmit motive power to the input shaft 22a of the differential gear unit 22. The coupling shaft portion 20c of the propeller shaft 20 and the second shaft part 20b of the propeller shaft 20 are integrally coupled to each other through welding or the like, for example. As shown in FIG. 3, the second hollow shaft 32 is formed with a second hole part (an inner space) 32a in a cylindrical shape extending through the second hollow shaft 32 in a rotation axis direction of the second hollow shaft 32, that is, in the direction of the rotation axis CL of the propeller shaft 20. In addition, a disk-shaped second cover 36 covering an opening of the second hollow shaft 32, the opening located on the opposite side to the first universal joint 26 side, is fitted into an end portion of the second hollow shaft 32, the end portion located on the opposite side to the first universal joint 26 side.

As shown in FIG. 3, the first hollow shaft 30 is disposed inward of the second hollow shaft 32, and an end portion of the first hollow shaft 30, the end portion located on the opposite side to the first universal joint 26 side, is disposed in such as manner as to overlap with the end portion on the first universal joint 26 side of the second hollow shaft 32. In the present embodiment, of the first hollow shaft 30 and the second hollow shaft 32, a shaft located inward is the first hollow shaft 30. An outer circumference of the first hollow shaft 30 is formed with outer circumferential spline teeth (first outer circumferential spline teeth) 30b to be spline-fitted to inner circumferential spline teeth (first inner circumferential spline teeth) 32b formed on an inner circumference of the second hollow shaft 32. In the first hollow shaft 30 and the second hollow shaft 32 that are configured in the above manner, when the inner circumferential spline teeth 32b of the second hollow shaft 32 are spline-fitted to the outer circumferential spline teeth 30b of the first hollow shaft 30, the second hollow shaft 32 comes into fit with the first hollow shaft 30 in such a manner as to be non-rotatable relative to the first hollow shaft 30 and movable in the direction of the rotation axis CL of the propeller shaft 20. The end portion of the first hollow shaft 30 located on the opposite side to the first universal joint 26 side is an example of a second end portion distant from the first universal joint 26.

As shown in FIG. 3, the end portion opposite to the first universal joint 26 side of the first hollow shaft 30 is formed with grease holes (oil holes) 30c through the first hollow shaft 30 so as to communicate the inner space of the first hollow shaft 30, that is, the first hole part 30a of the first hollow shaft 30 with a first space A present between the outer circumferential spline teeth 30b of the first hollow shaft 30 and the inner circumferential spline teeth 32b of the second hollow shaft 32. The grease holes 30c include: multiple first holes 30c1 disposed at positions of the end portion opposite to the first universal joint 26 side of the first hollow shaft 30, the positions located closest to the first universal joint 26, the first holes 30c1 being arranged with predetermined intervals in the circumferential direction of the first hollow shaft 30; multiple third holes 30c3 disposed at positions of the end portion opposite to the first universal joint 26 side of the first hollow shaft 30, the positions located farthest from the first universal joint 26, the third holes 30c3 being arranged with predetermined intervals in the circumferential direction of the first hollow shaft 30; and multiple second holes 30c2 disposed at positions of the end portion opposite to the first universal joint 26 side of the first hollow shaft 30, the positions located between the first holes 30c1 and the third holes 30c3, the second holes 30c2 being arranged with predetermined intervals in the circumferential direction of the first hollow shaft 30.

As shown in FIG. 3, inside the first hollow shaft 30, there is fixed a bottomed cylindrical grease cover (a partitioning wall) 38 that divides the inner space of the first hollow shaft 30, that is, the first hole part 30a of the first hollow shaft 30 into a grease retaining chamber (a lubrication oil retaining chamber) B and a vacant chamber C. Usually, the vacant chamber C retains no grease Gr. However, the vacant chamber C may retain a small amount of the grease Gr. In particular, the vacant chamber C may retain the grease Gr in an amount less than an amount of the grease Gr retained in the grease retaining chamber (the lubrication oil retaining chamber) B. The grease cover 38 includes: an annular fixed part 38a fixed, through welding or the like, to an inner circumferential wall surface of the first hole part 30a at an intermediate position of the first hollow shaft 30, for example; and a bottomed cylindrical projection 38b projecting from the fixed part 38a toward an opening of the first hollow shaft 30, the opening located on the opposite side to the first universal joint 26 side, in such a manner as to form an annular gap B1 between the inner circumferential wall surface of the first hole part 30a of the end portion on opposite side to the first universal joint 26 side of the first hollow shaft 30 and the grease cover 38. The bottomed cylindrical projection 38b projects to a position corresponding to the grease holes 30c in an extending direction of the rotation axis of the first hollow shaft 30. Namely, in a cross section that passes through one of the oil holes 30c of the first hollow shaft 30 and that is perpendicular to the rotation axis of the first hollow shaft 30, the bottomed cylindrical projection 38b is closer to the rotation axis of the first hollow shaft 30 than the oil holes 30c are. The bottomed cylindrical projection 38b may project to a position corresponding to the grease holes 30c1, 30c2 and 30c3 in an extending direction of the rotation axis of the first hollow shaft 30. An outer diameter D1 of the bottomed cylindrical projection 38b of the grease cover 38 is set to be smaller than an inner diameter D2 of the first hollow shaft 30. The grease cover 38 is formed by pressing a steel plate, for example. The annular gap B1 is a partial space of the grease retaining chamber B divided by the grease cover 38, and the annular gap B1 communicates with the grease holes 30c. That is, the grease retaining chamber B is a space communicating with the grease holes 30c.

As shown in FIG. 3, to the end portion on the first universal joint 26 side of the first hollow shaft 30, there is fixed a cover member (a first cover) 40 in a cylindrical shape that accepts therein a distal end portion of the second hollow shaft 32, that is, the end portion on the first universal joint 26 side of the second hollow shaft 32, and defines a cylindrical-shaped first space D around an outer circumference of the end portion on the first universal joint 26 side of the first hollow shaft 30. An end portion 40a on the first universal joint 26 side of the cylindrical cover member 40 is fixed to the end portion on the first universal joint 26 side of the first hollow shaft 30 through welding or the like, for example. In addition, an annular seal member 42 is arranged between an end portion 40b located on the opposite side to the first universal joint 26 side of the cylindrical cover member 40, and the end portion on the first universal joint 26 side of the second hollow shaft 32.

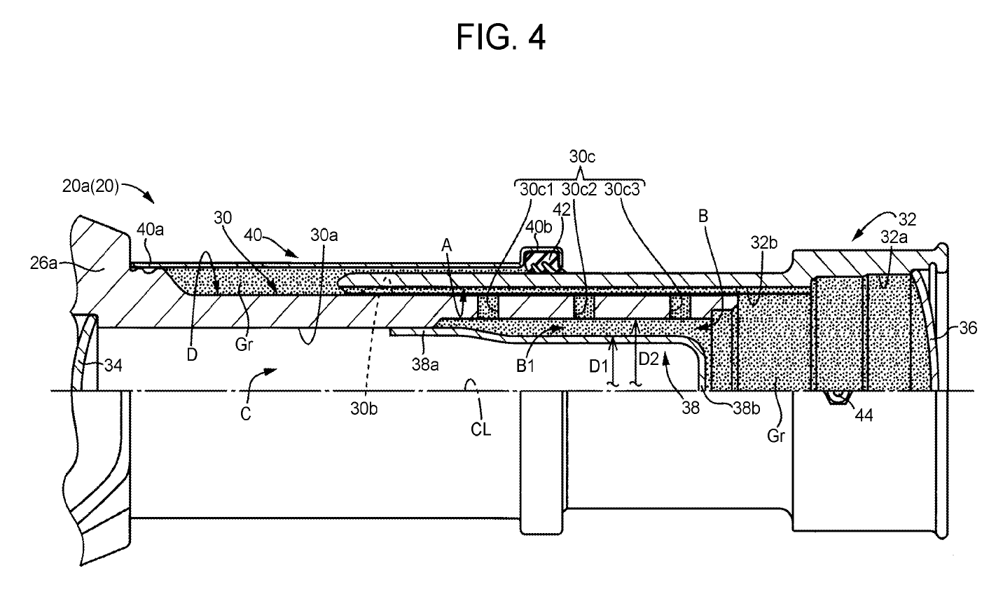

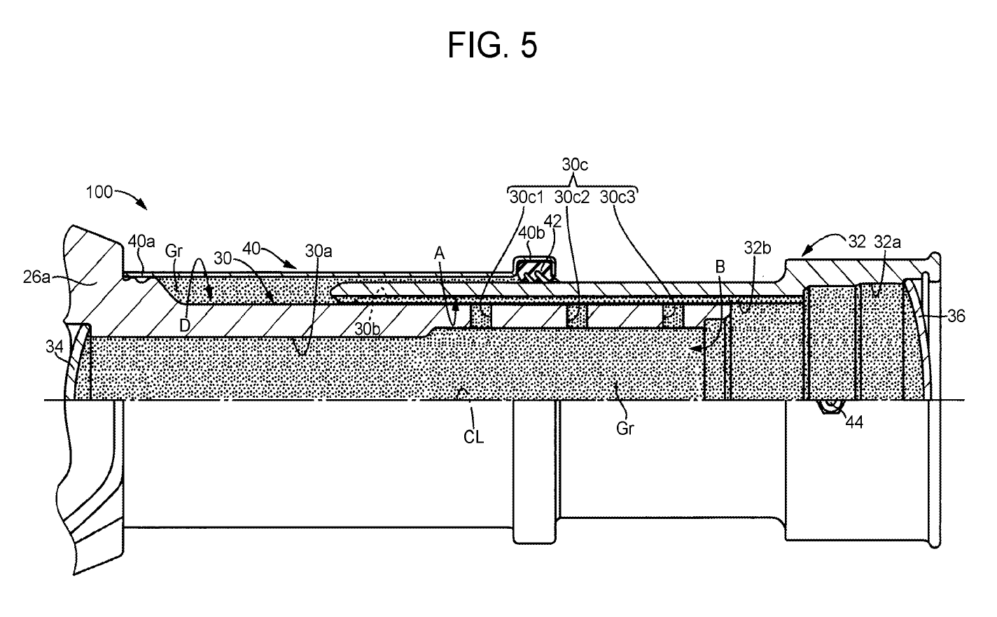

As shown in FIG. 3, there is provided a grease nipple 44 at the end portion of the second hollow shaft 32, the end portion located on the opposite side to the first universal joint 26 side, and this grease nipple 44 introduces the grease (the lubrication oil) Gr (see FIG. 4 and FIG. 5) supplied from a not-illustrated grease gun that is a grease supply device into the inside of the second hollow shaft 32, that is, into the propeller shaft 20. The grease nipple 44 functions as a check valve to prevent a reverse flow of the grease Gr in the second hollow shaft 32.

FIG. 4 is a view showing a state in which the grease Gr is supplied from the not-illustrated grease gun via the grease nipple 44 into the propeller shaft 20, and the inside of the propeller shaft 20 is filled with the grease Gr. FIG. 5 is a view showing a state in which the grease Gr is supplied into a propeller shaft 100 provided with no grease cover 38, and the inside of the propeller shaft 100 is filled with the grease Gr. Note that the propeller shaft 100 is different from the propeller shaft 20 in that the propeller shaft 100 is provided with no grease cover 38, but the other configurations are the same as those of the propeller shaft 20. The grease Gr with which the respective insides of the propeller shaft 20 and the propeller shaft 100 are filled is nonfluxional, and thus thousands of not-illustrated bubbles are present therein.

As shown in FIG. 5, in the propeller shaft 100 provided with no grease cover 38, when the inside of the propeller shaft 100 is filled with the grease Gr, the grease Gr is retained in the inner space of the first hollow shaft 30, that is, the grease retaining chamber B and the vacant chamber C are charged with the grease Gr. As shown in FIG. 4, in the propeller shaft 20, when the inside of the propeller shaft 20 is filled with the grease Gr, the inner space of the first hollow shaft 30 is divided into the grease retaining chamber B in which the grease Gr is retained (with which the grease Gr is charged) and the vacant chamber C in which no grease Gr is retained (with which no grease Gr is charged) by the grease cover 38. As shown in FIG. 4 and FIG. 5, in the charged state in which the respective insides of the propeller shaft 20 and the propeller shaft 100 are filled with the grease Gr, the amount of the grease Gr with which the inside of the propeller shaft 20 is charged is less than the amount of the grease Gr with which the inside of the propeller shaft 100 is charged by the amount of the grease Gr in the vacant chamber C.

In the propeller shaft 20 configured in the above manner, when the driven wheels 24 vertically move depending on the road surface conditions, the second hollow shaft 32 longitudinally moves in a direction approaching or away from the first hollow shaft 30, so that the length in the direction of the rotation axis CL of the propeller shaft 20 is changed. With this configuration, even in the case in which the driven wheels 24 vertically move depending on the road surface conditions during the vehicle traveling, the length in the direction of the rotation axis CL of the propeller shaft 20 is changed, and thus a suspension such as an independent suspension is suppressed from moving in the longitudinal direction of the vehicle.

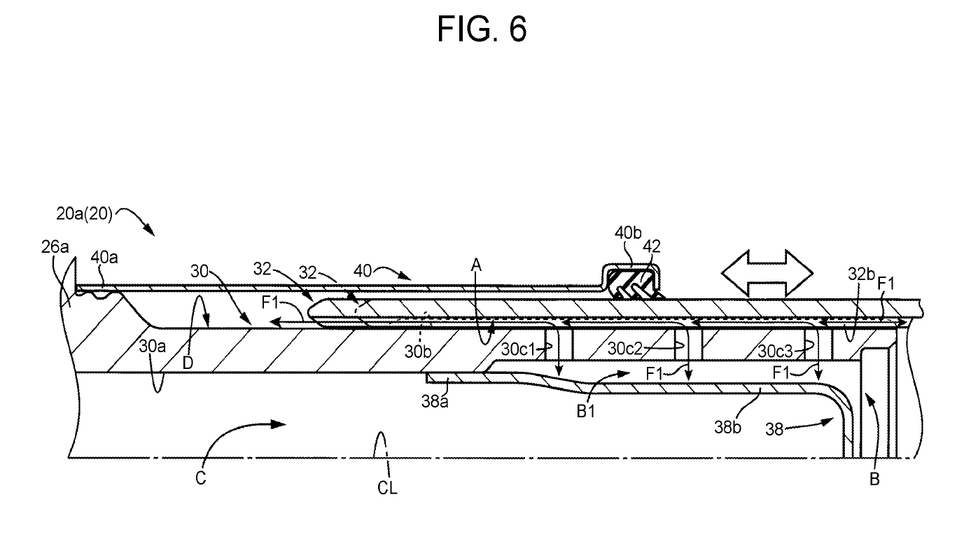

FIG. 6 is a view showing a flow of the grease Gr inside the propeller shaft 20 when the first hollow shaft 30 and the second hollow shaft 32 move in the direction apart from each other or move in the direction approaching each other during the vehicle traveling. Arrows F1 shown in FIG. 6 show flows of the grease Gr inside the propeller shaft 20. As shown in FIG. 6, when the first hollow shaft 30 and the second hollow shaft 32 move in the direction apart from each other or move in the direction approaching each other, for example, due to a difference in pressure between the grease retaining chamber B and the first space D, or due to centrifugal force of the propeller shaft 20 or the like, the grease Gr is brought to move between the grease retaining chamber B and the first space D. With this configuration, when the first hollow shaft 30 and the second hollow shaft 32 move in the direction apart from each other or move in the direction approaching each other, the grease Gr moving between the grease retaining chamber B and the first space D is supplied between the outer circumferential spline teeth 30b of the first hollow shaft 30 and the inner circumferential spline teeth 32b of the second hollow shaft 32.

As aforementioned, according to the propeller shaft 20 of the present embodiment, there is provided the grease cover 38 that divides the inner space of the first hollow shaft 30 into the grease retaining chamber B that retains the grease Gr therein and the vacant chamber C that retains no grease Gr therein. Hence, even in the case in which the inside of the propeller shaft 20 is charged with the grease Gr such that the grease retaining chamber B formed inside the first hollow shaft 30 is filled with the grease Gr, the vacant chamber C that retains no grease Gr therein is formed by the grease cover 38 in the inner space of the first hollow shaft 30, and thus it is possible to maintain lubrication property at the part where the outer circumferential spline teeth 30b of the first hollow shaft 30 and the inner circumferential spline teeth 32b of the second hollow shaft 32 are spline-fitted to each other, and also to suitably reduce the amount of the grease Gr with which the inside of the propeller shaft 20 is charged.

According to the propeller shaft 20 of the present embodiment, the first hollow shaft 30 is formed with the grease holes 30c extending therethrough, and the grease Gr in the grease retaining chamber B is supplied through the grease holes 30c to the part where the outer circumferential spline teeth 30b of the first hollow shaft 30 and the inner circumferential spline teeth 32b of the second hollow shaft 32 are spline-fitted to each other. Hence, the grease Gr in the grease retaining chamber B formed inside the first hollow shaft 30 flows through the grease holes 30c extending through the first hollow shaft 30, and is supplied to the spline-fitted part between the outer circumferential spline teeth 30b of the first hollow shaft 30 and the inner circumferential spline teeth 32b of the second hollow shaft 32; therefore, the grease Gr in the grease retaining chamber B can be suitably supplied to the part where the outer circumferential spline teeth 30b of the first hollow shaft 30 and the inner circumferential spline teeth 32b of the second hollow shaft 32 are spline-fitted to each other.

According to the propeller shaft 20 of the present embodiment, the outer circumference of the first hollow shaft 30 is formed with the outer circumferential spline teeth 30b to be fitted to the inner circumferential spline teeth 32b formed on the inner circumference of the second hollow shaft 32, and the grease cover 38 divides the inner space of the first hollow shaft 30 into the grease retaining chamber B and the vacant chamber C. Hence, even in the case in which the inside of the propeller shaft 20 is charged with the grease Gr such that the grease retaining chamber B formed inside the first hollow shaft 30 is filled with the grease Gr, the vacant chamber C retaining no grease Gr therein is formed by the grease cover 38 in the inner space of the first hollow shaft 30, and thus it is possible to maintain lubrication property at the spline-fitted part between the outer circumferential spline teeth 30b of the first hollow shaft 30 and the inner circumferential spline teeth 32b of the second hollow shaft 32, and also to suitably reduce the amount of the grease Gr with which the inside of the propeller shaft 20 is charged.

Furthermore, according to the propeller shaft 20 of the present embodiment, to the end portion on the first universal joint 26 side of the first hollow shaft 30, there is fixed a cover member 40 in a cylindrical shape that accepts therein a distal end portion of the second hollow shaft 32, that is, the end portion on the first universal joint 26 side of the second hollow shaft 32, and defines a cylindrical-shaped first space D around an outer circumference of the end portion on the first universal joint 26 side of the first hollow shaft 30. In addition, when the first hollow shaft 30 and the second hollow shaft 32 move in the direction apart from each other or move in the direction approaching each other, the grease Gr moving between the grease retaining chamber B and the first space D is supplied between the outer circumferential spline teeth 30b of the first hollow shaft 30 and the inner circumferential spline teeth 32b of the second hollow shaft 32. Hence, during the vehicle traveling, when the first hollow shaft 30 and the second hollow shaft 32 move in the direction apart from each other or move in the direction approaching each other, the grease Gr moving between the grease retaining chamber B and the first space D is supplied between the outer circumferential spline teeth 30b of the first hollow shaft 30 and the inner circumferential spline teeth 32b of the second hollow shaft 32. Accordingly, it is possible to suitably maintain lubrication property at the part where the outer circumferential spline teeth 30b of the first hollow shaft 30 and the inner circumferential spline teeth 32b of the second hollow shaft 32 are spline-fitted to each other.

According to the propeller shaft 20 of the present embodiment, the grease cover 38 is fixed inside the first hollow shaft 30, and thus it is possible to suitably divide the inner space of the first hollow shaft 30 into the grease retaining chamber B and the vacant chamber C.

In addition, according to the propeller shaft 20 of the present embodiment, the end portion opposite to the first universal joint 26 side of the first hollow shaft 30 is formed with the grease holes 30c, the grease cover 38 includes: the annular fixed part 38a fixed onto the inner circumferential wall surface of the first hollow shaft 30; and the bottomed cylindrical projection 38b projecting from the fixed part 38a toward the opposite side to the first universal joint 26 side, and the outer diameter D1 of the bottomed cylindrical projection 38b is smaller than the inner diameter D2 of the first hollow shaft 30. Therefore, it is possible to suitably enlarge the vacant chamber C in the inner space of the first hollow shaft 30 while maintaining lubrication property at the part where the outer circumferential spline teeth 30b of the first hollow shaft 30 and the inner circumferential spline teeth 32b of the second hollow shaft 32 are spline-fitted to each other.

Next, another embodiment of the present disclosure will be described. Note that the same reference numerals are added to common components to those of the aforementioned first embodiment, and description thereof will be omitted.

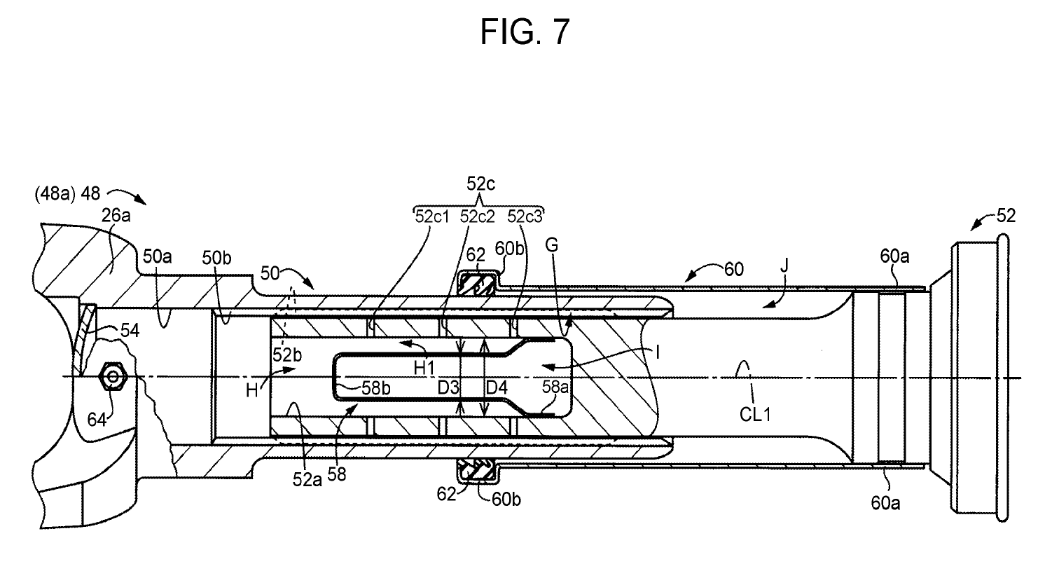

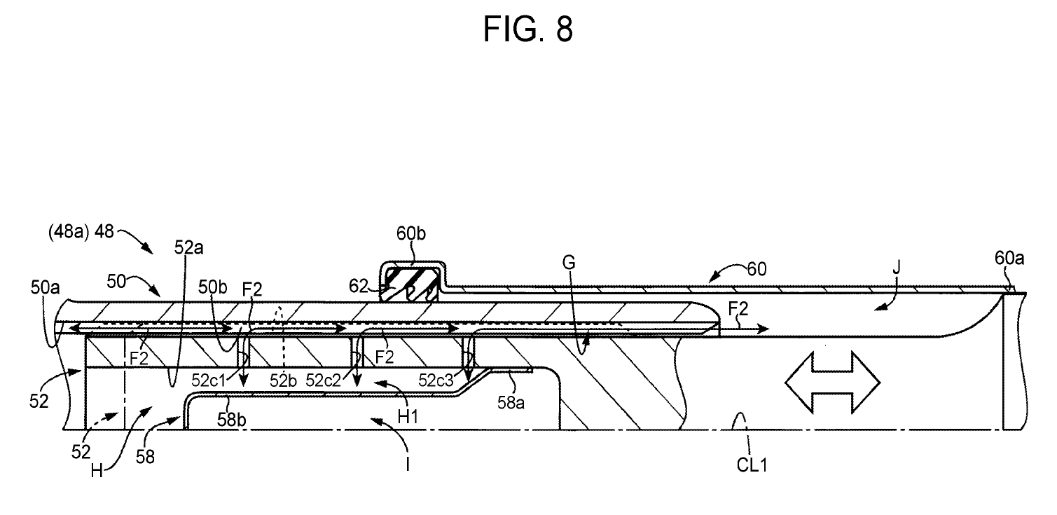

FIG. 7 and FIG. 8 are views explaining a propeller shaft (a propeller shaft for a vehicle) 48 of another embodiment of the present disclosure. Compared with the propeller shaft 20 of the first embodiment, the propeller shaft 48 of the present embodiment is different from the propeller shaft 20 in that a first hollow shaft 50 provided to a first shaft part 48a of the propeller shaft 48 is disposed outward of a second hollow shaft (an inward shaft) 52; in other words, of the first hollow shaft 50 and the second hollow shaft 52, a shaft located inward is the second hollow shaft 52; and other configurations are substantially the same as those of the propeller shaft 20 of the first embodiment. The first hollow shaft 50 is coupled to the first yoke 26a of the first universal joint 26 so as to transmit motive power to the first yoke 26a, and the second hollow shaft 52 is coupled to the first yoke 28a of the second universal joint 28 via the coupling shaft portion 20c and others so as to transmit motive power to the first yoke 28a.

As shown in FIG. 7, the first hollow shaft 50 is formed with a first hole part (an inner space) 50a in a cylindrical shape extending through the first hollow shaft 50 in a rotation axis direction of the first hollow shaft 50, that is, in a direction of a rotation axis (an axial line) CL1 of the propeller shaft 48. In addition, a disk-shaped first cover 54 covering an opening of the first hollow shaft 50, the opening located on the opposite side to the second universal joint 28 side, is fitted into the end portion of the first hollow shaft 50, the end portion located on the opposite side to the second universal joint 28 side. Further, the second hollow shaft 52 is formed with a second hole part (an inner space) 52a in a cylindrical shape formed by drilling the second hollow shaft 52 in the rotation axis direction of the second hollow shaft 52, that is, in the direction of the rotation axis CL1 of the propeller shaft 48.

As shown in FIG. 7, the first hollow shaft 50 is arranged such that the end portion located closer to the second universal joint 28 (on the second universal joint 28 side) of the first hollow shaft 50 overlaps with the end portion on opposite to the second universal joint 28 side of the second hollow shaft 52. An outer circumference of the second hollow shaft 52 is formed with outer circumferential spline teeth (second outer circumferential spline teeth) 52b to be spline-fitted to inner circumferential spline teeth (second inner circumferential spline teeth) 50b formed on the inner circumference of the first hollow shaft 50. In the first hollow shaft 50 and the second hollow shaft 52 that are configured in the above manner, when the outer circumferential spline teeth 52b of the second hollow shaft 52 are spline-fitted to the inner circumferential spline teeth 50b of the first hollow shaft 50, the second hollow shaft 52 comes into fit with the first hollow shaft 50 so as to be non-rotatable relative to the first hollow shaft 50 and movable in the direction of the rotation axis CL1 of the propeller shaft 48. The end portion of the second hollow shaft 52 located on the opposite side to the second universal joint 28 side is an example of a forth end portion distant from the second universal joint 28.

As shown in FIG. 7, the end portion opposite to the second universal joint 28 side of the second hollow shaft 52 is formed with grease holes (oil holes) 52c through the second hollow shaft 52 so as to communicate the inner space of the second hollow shaft 52, that is, the second hole part 52a of the second hollow shaft 52 with a space G between the inner circumferential spline teeth 50b of the first hollow shaft 50 and the outer circumferential spline teeth 52b of the second hollow shaft 52. The grease holes 52c include: multiple first holes 52c1 disposed at positions of the end portion opposite to the second universal joint 28 side of the second hollow shaft 52, the positions located farthest from the second universal joint 28, the first holes 52c1 being arranged with predetermined intervals in the circumferential direction of the second hollow shaft 52; multiple third holes 52c3 disposed at positions of the end portion opposite to the second universal joint 28 side of the second hollow shaft 52, the positions located closest to the second universal joint 28, the third holes 52c3 being arranged with predetermined intervals in the circumferential direction of the second hollow shaft 52; and multiple second holes 52c2 at positions of the end portion opposite to the second universal joint 28 side of the second hollow shaft 52, the positions located between the first holes 52c1 and the third holes 52c3, the second holes 52c2 being arranged with predetermined intervals in the circumferential direction of the second hollow shaft 52.

As shown in FIG. 7, inside the second hollow shaft 52, there is fixed a grease cover (a partitioning wall) 58 that divides the inner space of the second hollow shaft 52, that is, the second hole part 52a of the second hollow shaft 52 into a grease retaining chamber (a lubrication oil retaining chamber) H and a vacant chamber I. Usually, the vacant chamber I retains no oil. However, the vacant chamber I may retain a small amount of the grease Gr. In particular, the vacant chamber I may retain the grease Gr in an amount less than an amount of the grease Gr retained in the grease retaining chamber (the lubrication oil retaining chamber) H. The grease cover 58 includes: an annular fixed part 58a fixed to an inner circumferential wall surface of the second hole part 52a at an intermediate position of the second hollow shaft 52 through welding or the like, for example; and a bottomed cylindrical projection 58b projecting from the fixed part 58a toward an opening of the second hollow shaft 52, the opening located on the opposite side to the second universal joint 28 side, in such a manner as to form an annular gap H1 between an inner circumferential wall surface of the second hole part 52a at the end portion located opposite to the second universal joint 28 side of the second hollow shaft 52 and the grease cover 58. The bottomed cylindrical projection 58b projects to a position corresponding to the grease holes 52c in an extending direction of the rotation axis of the second hollow shaft 52. Namely, in a cross section that passes through one of the oil holes 52c of the second hollow shaft 52 and that is perpendicular to the rotation axis of the second hollow shaft 52, the bottomed cylindrical projection 58b is closer to the rotation axis of the second hollow shaft 52 than the oil holes 52c are. The bottomed cylindrical projection 58b may project to a position corresponding to the grease holes 52c1, 52c2 and 52c3 in an extending direction of the rotation axis of the second hollow shaft 52. An outer diameter D3 of the bottomed cylindrical projection 58b of the grease cover 58 is set to be smaller than an inner diameter D4 of the second hollow shaft 52. The grease cover 58 is formed by pressing a steel plate, for example. The annular gap H1 is a partial space of the grease retaining chamber H divided by the grease cover 58, and the annular gap H1 communicates with the grease holes 52c. That is, the grease retaining chamber H is a space communicating with the grease holes 52c.

As shown in FIG. 7, to the end portion on the second universal joint 28 side of the second hollow shaft 52, there is fixed a cover member (a second cover) 60 in a cylindrical shape that accepts therein a distal end portion of the first hollow shaft 50, that is, the end portion on the second universal joint 28 side of the first hollow shaft 50, and defines a cylindrical-shaped second space J around an outer circumference of the end portion on the second universal joint 28 side of the second hollow shaft 52. An end portion 60a on the second universal joint 28 side of the cylindrical cover member 60 is fixed, through welding or the like, to the end portion on the second universal joint 28 side of the second hollow shaft 52, for example. In addition, an annular seal member 62 is arranged between an end portion 60b opposite to the second universal joint 28 side of the cylindrical cover member 60 and the end portion on the second universal joint 28 side of the first hollow shaft 50. The end portion of the second hollow shaft 52 located on the second universal joint 28 side is an example of a third end portion adjacent to the second universal joint 28.

As shown in FIG. 7, there is provided a grease nipple 64 at the end portion opposite to the second universal joint 28 side of the first hollow shaft 50, and this grease nipple 64 introduces the grease (the lubrication oil) Gr supplied from a not-illustrated grease gun that is a grease supply device into the inside of the first hollow shaft 50, that is, into the inside of the propeller shaft 48.

FIG. 8 is a view showing a flow of the grease Gr inside the propeller shaft 48 when the first hollow shaft 50 and the second hollow shaft 52 move in the direction apart from each other or move in the direction approaching each other during the vehicle traveling. Arrows F2 shown in FIG. 8 indicate flows of the grease Gr inside the propeller shaft 48. As shown in FIG. 8, when the first hollow shaft 50 and the second hollow shaft 52 move in the direction apart from each other or move in the direction approaching each other, for example, due to a difference in pressure between the grease retaining chamber H and the second space J, or due to centrifugal force of the propeller shaft 48 or the like, the grease Gr is brought to move between the grease retaining chamber H and the second space J. With this configuration, when the first hollow shaft 50 and the second hollow shaft 52 move in the direction apart from each other or move in the direction approaching each other, the grease Gr moving between the grease retaining chamber H and the second space J is supplied between the inner circumferential spline teeth 50b of the first hollow shaft 50 and the outer circumferential spline teeth 52b of the second hollow shaft 52.

As aforementioned, according to the propeller shaft 48 of the present embodiment, the outer circumference of the second hollow shaft 52 is formed with the outer circumferential spline teeth 52b to be spline-fitted to the inner circumferential spline teeth 50b formed on the inner circumference of the first hollow shaft 50, and the grease cover 58 divides the inner space of the second hollow shaft 52 into the grease retaining chamber H and the vacant chamber I. Hence, even when the inside of the propeller shaft 48 is charged with the grease Gr such that the grease retaining chamber H formed inside the second hollow shaft 52 is filled with the grease Gr, the vacant chamber I retaining no grease Gr therein is formed in the inner space of the second hollow shaft 52 by the grease cover 58; thus, it is possible to maintain lubrication property at the part where the inner circumferential spline teeth 50b of the first hollow shaft 50 and the outer circumferential spline teeth 52b of the second hollow shaft 52 are spline-fitted to each other, and also to suitably reduce the amount of the grease Gr with which the inside of the propeller shaft 48 is charged.

In addition, according to the propeller shaft 48 of the present embodiment, to the end portion on the second universal joint 28 side of the second hollow shaft 52, there is fixed a cover member 60 in a cylindrical shape that accepts the distal end portion of the first hollow shaft 50 therein, and defines the cylindrical-shaped second space J around the outer circumference of the end portion on the second universal joint 28 side of the second hollow shaft 52. In addition, when the first hollow shaft 50 and the second hollow shaft 52 move in the direction apart from each other or move in the direction approaching each other, the grease Gr moving between the grease retaining chamber H and the second space J is supplied between the inner circumferential spline teeth 50b of the first hollow shaft 50 and the outer circumferential spline teeth 52b of the second hollow shaft 52. Hence, during the vehicle traveling, as shown in FIG. 8, when the first hollow shaft 50 and the second hollow shaft 52 move in the direction apart from each other or move in the direction approaching each other, the grease Gr moving between the grease retaining chamber H and the second space J is supplied between the inner circumferential spline teeth 50b of the first hollow shaft 50 and the outer circumferential spline teeth 52b of the second hollow shaft 52. Accordingly, it is possible to suitably maintain lubrication property at the part where the inner circumferential spline teeth 50b of the first hollow shaft 50 and the outer circumferential spline teeth 52b of the second hollow shaft 52 are spline-fitted to each other.

According to the propeller shaft 48 of the present embodiment, the grease cover 58 is fixed inside the second hollow shaft 52, and thus it is possible to suitably divide the inner space of the second hollow shaft 52 into the grease retaining chamber H and the vacant chamber I.

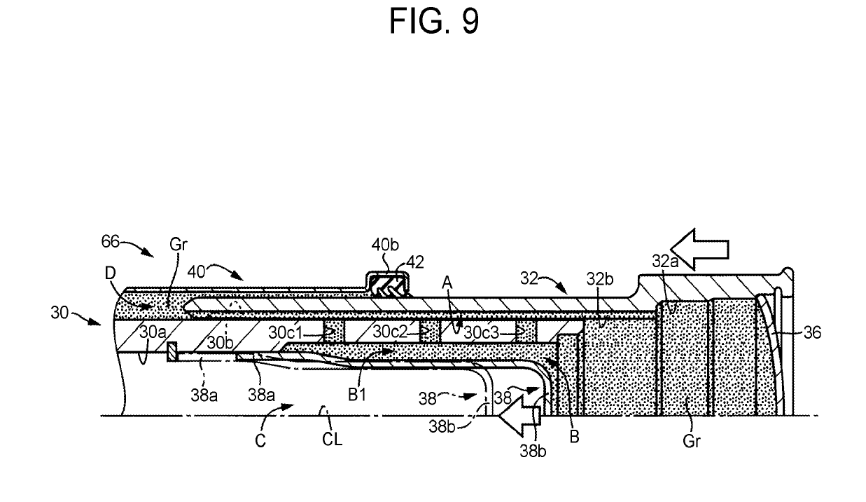

FIG. 9 is a view explaining a propeller shaft (a propeller shaft for a vehicle) 66 of another embodiment of the present disclosure. Compared with the propeller shaft 20 of the first embodiment, the propeller shaft 66 of the present embodiment is different from the propeller shaft 20 in that the fixed part 38a of the grease cover 38 is not fixed to the inner circumferential wall surface of the first hole part 30a of the first hollow shaft 30, but the grease cover 38 is provided in such a manner as to be movable in the direction of the rotation axis CL in the first hollow shaft 30; and the other configurations are substantially the same as those of the propeller shaft 20 of the first embodiment.

In the above-configured propeller shaft 66, during the vehicle traveling, when the first hollow shaft 30 and the second hollow shaft 32 move in the direction approaching each other, that is, when the second hollow shaft 32 moves in the direction approaching the first hollow shaft 30, the grease cover 38 is brought to move toward the first universal joint 26 side in the first hollow shaft 30.

As aforementioned, according to the propeller shaft 66 of the present embodiment, the grease cover 38 is provided in such a manner as to be movable inside the first hollow shaft 30 in the direction of the rotation axis CL. Hence, for example, even when the first hollow shaft 30 and the second hollow shaft 32 move in the direction approaching each other and the pressure in the propeller shaft 66 tends to be increased, the grease cover 38 moves in the direction of the rotation axis CL, to thereby suppress increase in pressure inside the propeller shaft 66; therefore, leakage of the grease Gr from the propeller shaft 66 is suitably suppressed.

As aforementioned, the embodiments of the present disclosure have been described in detail with reference to the drawings, but the present disclosure may also be applied to other aspects.

For example, in the aforementioned embodiments, the first hollow shaft 30 is formed with the grease holes 30c, but it is not always necessary to form the first hollow shaft 30 with the grease holes 30c. For example, the grease Gr with which the inner space of the end portion opposite to the first universal joint 26 side of the second hollow shaft 32 is charged may be supplied to the part where the outer circumferential spline teeth 30b of the first hollow shaft 30 and the inner circumferential spline teeth 32b of the second hollow shaft 32 are spline-fitted to each other. In addition, the second hollow shaft 52 is formed with the grease holes 52c, but it is not always necessary to form the second hollow shaft 52 with the grease holes 52c. For example, the grease Gr with which the inner space of the end portion on the first universal joint 26 side of the first hollow shaft 50 is charged may be supplied to the part where the inner circumferential spline teeth 50b of the first hollow shaft 50 and the outer circumferential spline teeth 52b of the second hollow shaft 52 are spline-fitted to each other.

Furthermore, in the aforementioned embodiments, each grease cover 38, 58 formed by pressing a steel plate is fixed to the inward shaft, which is one of each first hollow shaft 30, 50 and each second hollow shaft 32, 52, but the grease cover 38, 58 may be formed by an elastic material that is elastically deformable, such as a rubber material, for example. By composing the grease cover 38, 58 by an elastically deformable rubber material, even when the first hollow shaft 30, 50 and the second hollow shaft 32, 52 move in the direction approaching each other and the pressure in each propeller shaft 20, 48 tends to be increased, the pressure increase in the propeller shaft 20, 48 is suppressed by the elastic deformation of the grease cover 38, 58, to thereby suitably suppress leakage of the grease Gr from the propeller shaft 20, 48.

In the above-described embodiments, the fixed part 58a of the grease cover 58 is fixed to the inner circumferential wall surface of the second hole part 52a of the second hollow shaft 52, but the fixed part 58a of the grease cover 58 may not be fixed to the inner circumferential wall surface of the second hole part 52a of the second hollow shaft 52, and the grease cover 58 may be provided in such a manner as to be movable inside the second hollow shaft 52 in the direction of the rotation axis CL1.

The aforementioned embodiments are merely exemplary embodiments, and the present disclosure can be implemented in variously modified and improved forms based on the knowledge of those skilled in the art.

What is claimed is:

1. A propeller shaft for a vehicle, the propeller shaft comprising:
a first hollow shaft coupled to a first joint so as to transmit motive power to the first joint;
a second hollow shaft coupled to a second joint so as to transmit motive power to the second joint, the second hollow shaft being fitted to the first hollow shaft in such a manner as to be non-rotatable relative to the first hollow shaft, and to be movable in a rotation axis direction of the first hollow shaft, the first hollow shaft and the second hollow shaft being configured such that lubrication oil is supplied to a fitted part between the first hollow shaft and the second hollow shaft; and
a partitioning wall dividing an inner space of an inward shaft into a lubrication oil retaining chamber that retains the lubrication oil and a vacant chamber, the inward shaft being one of the first hollow shaft and the second hollow shaft, the inward shaft being inwardly fitted.

2. The propeller shaft for the vehicle according to claim 1, wherein
the inward shaft has oil holes, and
the inward shaft is configured such that the lubrication oil in the lubrication oil retaining chamber is supplied through the oil holes to the fitted part.

3. The propeller shaft for the vehicle according to claim 1, wherein
the inward shaft is the first hollow shaft,
the first hollow shaft includes first outer circumferential spline teeth on an outer circumference of the first hollow shaft, the second hollow shaft includes first inner circumferential spline teeth on an inner circumference of the second hollow shaft, and
the first outer circumferential spline teeth are configured to be spline-fitted to the first inner circumferential spline teeth.

4. The propeller shaft for the vehicle according to claim 3, wherein
a first cover having a cylindrical shape is fixed to a first end portion of the first hollow shaft, the first end portion being adjacent to the first joint,
the first cover defines a cylindrical first space around an outer circumference of the first end portion of the first hollow shaft, and a distal end portion of the second hollow shaft is disposed in the cylindrical first space,
when the first hollow shaft and the second hollow shaft move in a predetermined direction, the lubrication oil moving between the lubrication oil retaining chamber and the cylindrical first space is supplied between the first outer circumferential spline teeth of the first hollow shaft and the first inner circumferential spline teeth of the second hollow shaft, and
the predetermined direction is any one of a direction where the first hollow shaft and the second hollow shaft move apart from each other and a direction where the first hollow shaft and the second hollow shaft approach each other.

5. The propeller shaft for the vehicle according to claim 1, wherein
the inward shaft is the second hollow shaft,
the second hollow shaft includes second outer circumferential spline teeth on an outer circumference of the second hollow shaft, the first hollow shaft includes second inner circumferential spline teeth on an inner circumference of the first hollow shaft, and
the second outer circumferential spline teeth are configured to be spline-fitted to the second inner circumferential spline teeth.

6. The propeller shaft for the vehicle according to claim 5, wherein
a second cover having a cylindrical shape is fixed to a third end portion of the second hollow shaft, the third end portion being adjacent to the second joint,
the second cover defines a cylindrical second space around an outer circumference of the third end portion of the second hollow shaft, and a distal end portion of the first hollow shaft is disposed in the cylindrical second space,
when the first hollow shaft and the second hollow shaft move in a predetermined direction, the lubrication oil moving between the lubrication oil retaining chamber and the cylindrical second space is supplied between the second inner circumferential spline teeth of the first hollow shaft and the second outer circumferential spline teeth of the second hollow shaft, and
the predetermined direction is any one of a direction where the first hollow shaft and the second hollow shaft move apart from each other and a direction where the first hollow shaft and the second hollow shaft approach each other.

7. The propeller shaft for the vehicle according to claim 1, wherein
the partitioning wall is fixed inside the inward shaft.

8. The propeller shaft for the vehicle according to claim 1, wherein
the partitioning wall is provided inside the inward shaft in such a manner as to be movable relative to the inward shaft in a rotation axis direction of the inward shaft.

9. The propeller shaft for the vehicle according to claim 2, wherein
the inward shaft is the first hollow shaft,
the first hollow shaft has a first end portion adjacent to the first joint, a second end portion distant from the first joint, and the oil holes provided at the second end portion,
the partitioning wall includes an annular fixed part fixed to an inner circumferential wall surface of the first hollow shaft, and a bottomed cylindrical projection projecting from the fixed part toward a second end portion side, and
an outer diameter of the bottomed cylindrical projection is smaller than an inner diameter of the first hollow shaft.

10. The propeller shaft for the vehicle according to claim 2, wherein
the inward shaft is the second hollow shaft,
the second hollow shaft has a third end portion adjacent to the second joint, a forth end portion distant from the second joint, and the oil holes provided at the forth end portion,
the partitioning wall includes an annular fixed part fixed to an inner circumferential wall surface of the second hollow shaft, and a bottomed cylindrical projection projecting from the fixed part toward a forth end portion side, and
an outer diameter of the bottomed cylindrical projection is smaller than an inner diameter of the second hollow shaft.

11. The propeller shaft for the vehicle according to claim 7, wherein
the partitioning wall is composed by an elastic material that is elastically deformable.

12. The propeller shaft for the vehicle according to claim 1, wherein
the inward shaft is the first hollow shaft having oil holes, and
the lubrication oil retaining chamber is a space communicating with the oil holes.

13. The propeller shaft for the vehicle according to claim 1, wherein
the inward shaft is the second hollow shaft having oil holes, and
the lubrication oil retaining chamber is a space communicating with the oil holes.

14. The propeller shaft for the vehicle according to claim 1, wherein
the vacant chamber retains no lubrication oil.

15. The propeller shaft for the vehicle according to claim 9, wherein
the bottomed cylindrical projection projects to a position corresponding to the oil holes in an extending direction of the rotation axis of the first hollow shaft.
